(19) United States
(12) Patent Application Publication
(10) Pub. No.: US 2008/0013927 A1
(43) Pub. Date: Jan. 17, 2008

(54) Supporting user navigation through commercials

(75) Inventors: Declan Patrick Kelly, Eindhoven (NL); Bei Wang, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/571,433

(22) PCT Filed: Jun. 24, 2005
(86) PCT No.: PCT/IB05/52102

§ 371 Date: Dec. 29, 2006

Related U.S. Application Data
(60) Provisional application No. 60/584,194, filed on Jun. 30, 2004.

(51) Int. Cl. H04N 7/26

(52) U.S. Cl. 386/124

(57) ABSTRACT

The detection and recording of commercials (12) within content (10) to provide viewers with a choice to avoid watching commercials or view commercial content at a selected time. This invention proposes a way to allow the user to navigate through commercials (12) of interest without having to sit linearly through the commercials by recording the commercials and presenting the commercials to the user as a set of thumbnails, a menu or a Table of Contents mechanism. Content analysis algorithms can be used to choose the most representative key frame for the thumbnail. The invention can be used in conjunction with techniques to automatically delete commercials from recordings. The commercials are not watched by the viewer during initial viewing but are presented at user-selected times so the user can selectively view the commercials.

Interactive TV Systems are currently being launched, such as the Multimedia Home Platform (MHP) that provides viewers with the capability of interacting with content, including commercials. Digital TV channels with MHP services including an electronic program guide (EPG) and the digital teletext services of the individual channels currently exist. The EPG can display program information for every digital TV channel. The EPG can run in a Digital Video Broadcasting (DHB) MHP system. The EPG typically runs as an identical application on all the digital TV channels and looks the same on every channel. The provision of EPG makes it easier for viewers to use digital TV. By providing a system with such commonality that looks and operates the same everywhere, users become used to the EPG. Systems like MHP offer numerous possibilities for future digital television applications. EPG will undoubtedly undergo further development as future versions of MHP become available. Additional EPG services could provide features such as reminders and possibilities for personalizing. MHP terminals with hard disks are currently being and will become popular. Personal video recording (PVR) functions also can be added to the EPG. The full use of the PVR role will be available in future MHP systems, probably MHP 2.0.

It is envisioned that digital TV channels will provide interactive, information services, referred to as digital teletext. These digital teletext services, or the like, are the core of interactive services for digital TV. These digital teletext services provide a platform for interactive services. Additionally, digital teletext services can provide information services containing images, graphics, text and other data. Digital teletext systems can provide interactive services on every channel. Unlike EPG, Digital teletext systems can be customized and, therefore, be different on every channel.

There are numerous prior art references that are dedicated to the detection of commercials within broadcast content. The vast majority of these references are directed towards the removing commercials from the program content in one way or another. These prior art references allow the user to avoid viewing commercials based on the underlying assumption that the commercials have no value to the viewer; however, there are commercials that the viewer will find interesting and the content of these commercials should be preserved for the viewer. An example of a commercial that viewers found interesting is a Britney Spears commercial that aired for Pepsi® during a Superbowl and received higher view ratings than the football game itself. In the similar manner, numerous commercials have points of interest that make viewers interested in viewing the commercial content. Another instance of commercials of interest to viewers is where the item being advertised by the commercial is of interest to that particular viewer. Viewers perceive interesting commercials as information rather than advertising. Highly targeted commercials tend to be interesting to the viewers for which they are targeted. If the viewer finds the subject matter of the commercial interesting, there is a high probability that the viewer will watch the commercial given the opportunity.

Interactive TV Systems, such as the MHP, provide viewers with the ability to interact with content, including commercials. Future versions of the these interactive systems, as currently envisioned, will support Internet connectivity, giving viewers the ability to buy products advertised through e-commerce services. By supplying the viewer with interactive Internet connectivity, more detailed information can be provided to the viewer. The ability of the viewer to purchase or receive more detailed information on advertised items will increase the perceived value of highly targeted advertisements. A problem that exists within the prior art of providing highly targeted advertising as well as the purchasing ability for advertised items through interactive Internet connectivity is that the time it takes to actually execute an e-commerce transaction will generally take longer than the length of the commercial. Thus, completing the e-commerce transaction distracts form the viewing of the actual content.

Much of the existing prior art is related to automatic deletion of commercial content to allow users to view content without any commercials. Typically, these prior art references time-shift the program content with the commercials deleted so that the content without commercials appears as a single piece of content. A problem that exists within the prior art is that the deletion of commercial content directly threatens the business models of broadcasters that are support by the revenue from the advertisements that are being viewed. As time-shifted viewing becomes more commonplace, it is entirely possible that there will not be any advertisers willing to pay for programming if their commercials are not being viewed to an extent that can justify paying for the programs. This creates a situation in which there ultimately may not be any program channels left to time-shift. Therefore, time shifting should be accomplished in a manner that allows viewers to watch commercials at a desired time rather than eliminating the commercial content altogether. Accordingly, it is worthwhile to consider alternatives that allow the user to navigate through commercial content.

This invention proposes a method and apparatus that allows the user to navigate through commercials of interest without viewing commercials while watching the program content. The invention can be used in conjunction with features that facilitate user's skipping commercials. It is envisioned by the invention that assumes storage is available, typically HDD storage in either the TV or PVR.

The inventive concept is to explicitly record the commercials and to provide a user interface that allows the viewer the ability to select commercials to watch from thumbnail images. The invention provides the viewer with the ability to select commercials of interest rather than deleting the commercials. The method of the invention envisions presentation of commercials at two preferred times, although it will be readily apparent to those skilled in the art that there are numerous periods, including but not limited to user determined time periods, wherein recorded commercials can be viewed. The first preferred time period is at the end of a program, having a menu presented with the commercials from that program shown to the user as a series of thumbnail images. The second preferred time period is user selection of a ‘My Commercials’ folder provided in the storage system with a Table of Contents (or a series of thumbnail images) so that commercials of interest can be saved for later viewing. By selecting and activating the thumbnail the user can view the commercials, similar to chapter selection in DVD menus.

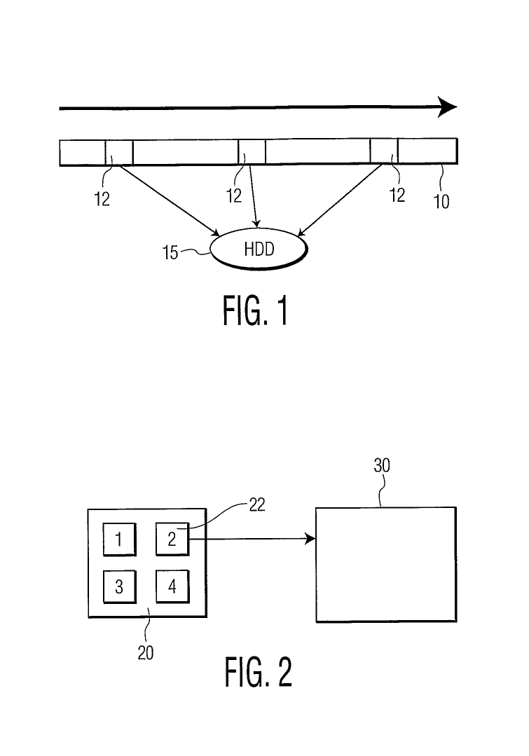

FIG. 1 is an illustration of the system of the invention for detecting and recording commercials with program content.

FIG. 2 is a block diagram illustrating the playing of prerecorded commercials recorded in FIG. 1.

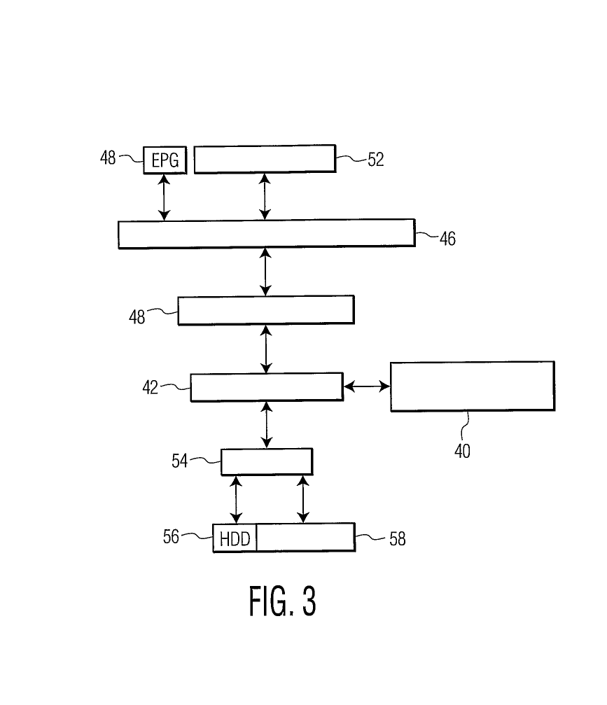

FIG. 3 is a block diagram illustrating an implementation of the invention.

The invention seeks to record commercials and provide a user interface to allow viewers with the capability to select commercials from a Table of Content, menu or set of thumbnail images at a desired time to watch the commercials. The invention provides the viewer with the ability to select commercials of interest rather than deleting the commercials. As envisioned, the foregoing features can be implemented by the player or by the broadcaster in an interactive TV system. Newer standards (such as MHP 2.0) will include support for storage; therefore, the broadcaster will be able to transmit applications to provide the features that will be retained with the storage system. The storage of contents on local hard disc media is an issue being considered for future version of MHP and is actively being pursued by TV Anytime. Discussions related extensions for MHP 2.0 have included Local Home Network that provides objective connection to a large variety of devices including wireless connections. The invention envisions a user interface that provides broadcasters with the ability to control the look and feel of the commercial presentations.

Additional modifications to the inventive concept provide the user with the capability to select commercials of interest during viewing and view only the selected commercials after the program has completed, or have the selected commercials placed in their ‘My Commercials’ folder for later viewing. In this manner, the viewer can select only those commercials that are of interest.

The invention also envisions that content analysis algorithms can be used to choose the most representative key frame for the thumbnail. Content analysis algorithms can be used in conjunction with techniques that provide the automatic deletion of commercials from recordings. The commercials are not watched by the viewer during initial viewing but are presented as thumbnails at the end of the program so the user can selectively view the commercials.

One manner of identifying commercials is by Content Reference Identifiers (CRIDs) within a TV Anytime system which provides CRIDs as location independent references and defines a process wherein CRIDs can be used to resolve times and locations of the content. Based on the CRIDs the system can identify the commercials and also identify duplicates, which of course need not be recorded. CRIDs provide resolution of program related descriptive metadata with corresponding program location data published over a different distribution network or at a different time. A content publisher can release the same audio/video material on a number of platforms, or numerous times. CRIDs can associate these different publications in a single description. The foregoing is a example of identifying commercials within the TV Anytime system that can be used with content analysis algorithms, other embodiments for identifying commercials will be readily apparent to those skilled in the relevant art.

Referring to FIG. 1., the system of the invention detects and records commercials in the programs. As the program 10 progresses from beginning to end as indicated by the arrow labeled Time, the commercials 12 are detected and recorded on a hard disc drive (HDD) 15. In a simple implementation of the invention, the system will record all commercials 12 during viewing (or recording). As envisioned, the recording of commercials 12 is independent of whether the actual content of program 10 is also being recorded or whether commercials are being automatically skipped (e.g. by generating PlayLists that include the content without the commercials). Preferably, at the end of the program 10, the system will present the set of commercials 12 from that program 10 displayed as thumbnails. The user can select a commercial to watch from one of the thumbnails. In the preferred embodiment, after watching a selected commercial 12, the system again presents the thumbnail menu. The user interface can provide an option to save a commercial (for example, collected in a ‘My Commercials’ folder). When the user is finished navigating the commercials, the thumbnail menu is removed and any unsaved commercials are deleted.

FIG. 2 is a high-level block diagram illustrating the playing of prerecorded commercials by the system 30. Either at the end of a program or as a result of viewer selection, a menu 20 is presented containing thumbnails 22 that were recorded in the folder ‘My Commercials’ 24 during the playing of a program. The thumbnails 22 represent the commercials that would be recorded in the scenario represented in FIG. 1. The user can select one of the thumbnails 22 via the user interface, resulting in the system playing that commercial represented by the thumbnail 22 including any interactivity that is available. Once a commercial represented by the thumbnail 22 has been played, the menu 20 is once again displayed,

Another option that can be provided by the invention is that during initial viewing, the user can select the commercials of interest by pressing a ‘Save’ button and only those commercials selected will be presented at the end of the program. Preferably, this option would have the system record all commercials and those that the user has selected will be displayed at the end of the program. Such an embodiment is preferred because the user cannot be expected to choose ‘Save’ at the beginning of a commercial and because the user may desire to view additional commercials that were not selected. It is envisioned that the set of ‘Saved’ commercials could very well span multiple programs.

The invention envisions that the user will be able to bring up the commercial thumbnails at any point in the content and watch a commercial before returning to the content (either live content or recorded on a HDD).

A set of features expected to extend the MHP standard to include storage can be used to implement the invention upon a MHP platform. The following concepts for implementing these extensions within the MHP standard have been proposed and are envisioned by the invention. The broadcaster sends an application to support recording of commercials. This application will initiate recording of all commercials to the local storage (during live viewing). It is envisioned that each commercial can potentially contain features to signal the application and have the commercial identify itself to the application so that a thumbnail, or some other form of entry is provided within the system. In MHP these features could include an event with data (requiring less than 1K bytes) to indicate the title of the commercial and to include the thumbnail or the event data could indicate a file in the Object Carousel that contains the thumbnail and title. Also MHP Stream Events can be used to signal the start and the end of commercials. The application can then display the thumbnails at any time as provided by the broadcaster. This will be possible in response to user request or in response to an event. Using an event, the broadcaster can display the commercial thumbnails at particular times such as during the program credits at the end of the program. If the program is recorded (as compared to being watched live) then the commercials do not need to have been recorded. Even if the commercials have been automatically skipped, on playback, the application will be able to detect missing commercials so it will either not present anything or else load alternative version of the commercials through the Internet (such as text only).

FIG. 3 illustrates a generalized implementation of a MHP platform 50. The uppermost layer contains one or more MHP applications 52 that can execute in parallel. The EPG 48 will run at this uppermost level and provide interactivity for the commercials that are navigated by the user. The system comprises multiple layers including a Virtual Machine(VM) 44 that is preferably JAVA based running on an operating system 42 within the player/recorder. VM 44 will interface with the MHP Applications 52, such as the EPG 48, through the MHP Application Program Interface 46. The operating system 42 interfaces with drivers 54 that enable system access to the player/recorder hardware 58. An Application Manager 40 starts and stops applications and typically operates a navigator that can be employed by the invention to navigate through commercials that have been recorded within the HDD 56 in the system hardware 58.

The foregoing description describes the embodiments most preferred by the inventors for performing the invention. Variations of the foregoing embodiments will be readily apparent to those skilled in the art, therefore, the invention should be measured by the appended claims.

1. A player/recorder (58) for digital media comprising:
a detection device (52) within the player/recorder that detects commercials within program content (10);
a mechanism (15) within the player/recorder (58) that records commercials
a presentation device within the recorder that displays recorded commercials at selected times.

2. The player/recorder (58) of claim 1, wherein the presentation device displays a menu (20) for selection of recorded commercials.

3. The player/recorder of claim 2, wherein the presentation device displays the menu (20) for recorded commercials as a set of thumbnail images (22).

4. The player/recorder of claim 2, wherein the presentation device displays the menu (20) for recorded commercials at the end of a program.

5. The player/recorder of claim 2, wherein the presentation device displays the menu (20) for recorded commercials during presentation of credits for a program.

6. The player/recorder of claim 1, wherein the presentation device allows user selection for viewing of recorded commercials.

7. The player/recorder of claim 1, wherein the presentation device displays provides an interactive display.

8. The player/recorder of claim 1, wherein the presentation device provides options to save commercials.

9. The player/recorder of claim 8, wherein the presentation device provides options to save commercials while viewing.

10. The player/recorder of claim 8, wherein the presentation device provides recorded commercials within a thumbnail menu (22).

11. The player/recorder of claim 1, wherein the presentation device provides options for recorded commercials to be saved on a storage device and identified in a Table of Contents menu for the storage device.

12. A method for recording a set of content comprising:
providing a player/recorder (58) having a detection device (52) within that can detect that commercials (12) within the set of content (10);
recording commercials that are broadcast within the set of content;
eliminating commercials from the set of content to create a commercial free set of content; and
creating a mechanism (20) that allows for viewing of recorded commercials.

13. The method of claim 12, wherein the mechanism further comprises a presentation device within the player/recorder (58) that displays a menu (20) allowing users to select recorded commercials for viewing.

14. The method of claim 12, wherein recording is triggered by an event to start of commercial.

15. The method of claim 14, wherein recording is triggered by the event that is a MHP Stream Event.

16. The method of claim 15, wherein recording further comprises the MHP event identifies a title of the commercial to be recorded and creates a thumbnail image to represent the commercial.

17. The method of claim 15, wherein the MHP event identifies a file in a content object carousel that identifies a title and a thumbnail image.

18. The method of claim 17, wherein the file in a content object carousel can contain all commercials in a commercial break or all commercial within a complete program.

19. The method of claim 12, wherein detection and initiation of recording is initiated by TVAnytime CRIDs.

20. The method of claim 19, wherein TVAnytime CRIDs link a file identifying recorded commercials and actual commercials recorded.
